(19) United States
(12) Patent Application Publication
(10) Pub. No.: US 2012/0308711 A1
(43) Pub. Date: Dec. 6, 2012

(54) Drink

(75) Inventors: Bettina Schwaier, Munchen (DE); Jurgen Gierke, Wain (DE); Peter Horlacher, Bellenberg (DE); Sandra Reitlinger, Illertissen/Au (DE); Katja Beck, Illertissen/Au (DE)

(73) Assignee: COGNIS IP MANAGEMENT GMBH, DUSSELDORF (DE)

(21) Appl. No.: 13/577,373

(22) PCT Filed: Jan. 28, 2011
(86) PCT No.: PCT/EP11/00402

§ 371 Date: Aug. 6, 2012

(30) Foreign Application Priority Data
Feb. 6, 2010 (EP) EP10001238

(51) Int. Cl. A23L 2/52; A23D 9/00; A23D 7/005; A23L 2/38

(52) U.S. Cl. 426/576; 426/590; 426/609; 426/602

(57) ABSTRACT

The present invention relates to a drink which is an oil-in-water emulsion and which comprises hydrocolloids, where the hydrocolloids are a mixture of gellan and pectin. The hydrocolloids prevent or retard the creaming of the oil phase or fat phase of the oil-in-water emulsion.

The present invention relates to a drink which is an oil-in-water emulsion and which comprises hydrocolloids, where the hydrocolloids are a mixture of gellan and pectin. The hydrocolloids prevent or retard the creaming of the oil phase or fat phase of the oil-in-water emulsion.

It is known that hydrocolloids such as pectin, gellan, carboxymethylcellulose (CMC) etc. are used for stabilizing drinks, i.e. are used for preventing or retarding the settling of particles in drinks. The particles here are e.g. particles of fruit pulp or fruit flesh which would settle in the drink without stabilization. This stabilization is achieved primarily by increasing the viscosity of the drinks by means of the viscosity-increasing hydrocolloids used here.

The creaming of particles in drinks is prevented by adding auxiliaries such as emulsifiers or so-called “weighting agents”. This is likewise known from the prior art. The so-called “weighting agents” lead to an alignment of the density of the particles suspended in the drinks and of the continuous, liquid phase surrounding them. The “weighting agents” here increase e.g. the density of oil particles or fat particles which are dispersed in aqueous phase so that the oil particles or fat particles no longer cream.

There is the need to retard or to prevent the creaming of the oil phase or fat phase in drinks which are oil-in-water emulsions, and which have a difference in density between the oil phase and fat phase, without, in exchange, having to rely mandatorily on emulsifiers or weighting agents.

U.S. Pat. No. 6,627,245 discloses stable, homogeneous, emulsifier-free suspensions of hydrophobic substances which comprise a thickener, where, inter alia, pectin and gellan are specified as thickeners. Here, the thickener is preferably used in a concentration such that the viscosity of the suspension is at least 50 meas. Below this viscosity, the suspensions are not stable. High-viscosity suspensions of this type are unsuitable for many drink applications because they do not meet the expectation of the consumer with regard to the viscosity of a drink

There is thus still the need to retard or to prevent the creaming of the oil phase or fat phase in drinks which are oil-in-water emulsions and which have a difference in density between the oil phase and fat phase without, in exchange, the viscosity of the drinks having to be increased to 50 mPas or greater.

WO 2005/102074 discloses in example A a drink which is a protein suspension which is stabilized by pectin.

U.S. Pat. No. 5,641,532 discloses in example 1 a drink which is an oil-in-water emulsion which is stabilized with gellan.

U.S. 2007/0178213 discloses aerated milk products which comprise, inter alia, gellan.

WO 2008/128765 discloses a CLA-containing yoghurt drink which comprises pectin.

WO 2007/066234 discloses a drink which is an emulsion which is stabilized with pectin.

Nahrung, Volume 40, pages 60-67 (1996) discloses whey protein emulsions which comprise modified pectins.

U.S. Pat. No. 7,147,885 discloses in claim 8 a dispersion stabilizer comprising isolated acetylated gellan and pectin.

It is an object of the present invention to provide a drink which is an oil-in-water emulsion in which an oil phase or fat phase is dispersed in a water phase, and in which the oil phase or fat phase has a lower density than the water phase, the aim being to prevent or at least retard or reduce to an extent the creaming of oil particles or fat particles in the drink without emulsifiers or weighting agents having to be used mandatorily for this purpose. In this connection, the sensory quality of the drink, the so-called mouth feel, should not be adversely affected, or at least not considerably adversely affected, by the measure which is taken in order to prevent or at least retard or reduce to an extent the creaming of oil particles or fat particles in the drink. Moreover, it should be possible to adjust the viscosity of the drink to the lowest possible value, e.g. to less than 50 mPas, and nevertheless to achieve the desired reduction in creaming. This object is achieved by the drink which is defined in the claims of the present specification. This drink is one subject matter of the present invention.

Here, it is an essential element of the present invention that a mixture of gellan and pectin is used as hydrocolloid. The use of gellan on its own or the use of pectin on its own in many cases does not allow a stable emulsion to be obtained, unless gellan or pectin is used in such a large amount that the viscosity of the emulsion becomes undesirably high (see in this respect U.S. Pat. No. 6,627,245). The use of the mixture of gellan and pectin according to the invention makes it possible to obtain stable emulsions without the viscosity of the emulsion having to be undesirably high.

A further subject matter of the present invention is a fat powder which, as intermediate, can serve for producing the drink according to the invention. The fat powder according to the invention is defined in the claims of the present specification.

A further subject matter of the present invention is an emulsion which, as intermediate, can serve for producing the drink according to the invention. The emulsion according to the invention is defined in the claims of the present specification.

A further subject matter of the present invention is a method for producing the drink according to the invention from the fat powder according to the invention.

A further subject matter of the present invention is a method for producing the drink according to the invention from the emulsion according to the invention.

A further subject matter of the present invention is the use of a hydrocolloid for retarding or for preventing the creaming of the oil phase or fat phase in a drink which is an oil-in-water emulsion.

Surprisingly, it has been found that fat powders which comprise hydrocolloids and are dispersed in an aqueous phase such that aqueous phase and fat powder together produce a drink, cream only in a very retarded manner, if at all, in this drink. In this connection, it is possible, by selecting suitable hydrocolloids, namely a mixture of gellan and pectin, to ensure that the viscosity of the drink is not significantly increased. This can be advantageous because an excessively high viscosity can reduce the acceptance of a drink by the consumer in certain cases.

Instead of the fat powders, it is also possible for an oil to be emulsified in an aqueous phase, in which case, the emulsion obtained in this way comprises a hydrocolloid. In this connection as well, a drink is obtained in which the oil creams only in a very retarded manner, if at all. In this case too, it is possible, by selecting suitable hydrocolloids, namely a mixture of gellan and pectin, to ensure that the viscosity of the drink is not significantly increased. This can be advantageous because an excessively high viscosity can reduce the acceptance of a drink by the consumer in certain cases.

The drinks according to the invention are oil-in-water emulsions. Here, a nonpolar oil phase or fat phase is emulsified or suspended in a polar water phase.

Suitable as oil phase or fat phase are any desired oils and/or fats suitable for drinks Preferably, the oils or fats have a density of 0.8-0.99 kg/l, preferably 0.9-0.96 kg/l. Fats are understood as meaning substances which are solid at 20° C.; oils are understood as meaning substances which are liquid at 20° C.

In particular, suitable oils or fats are fatty acids esterified with glycerol. Depending on the degree of esterification, monoglycerides, diglycerides or triglycerides or mixtures of these are contemplated. According to the invention, triglycerides of fatty acids are preferred oils or fats.

Furthermore, suitable oils or fats are: glycerides of polyunsaturated fatty acids (PUFAs) such as e.g. fish oil, oils from algae or plant fats and derivatives thereof, omega-3/or omega-6/or omega-9 fatty acids in the form of glycerol esters (glycerides).

Also suitable as oils or fats are phytosterols or fatty acid esters of phytosterols. These oils or fats are only suitable if the oil phase or fat phase of the drink according to the invention has a lower density than the aqueous phase.

Furthermore, suitable oils or fats are phytostanols or fatty acid esters of phytostanols. These oils or fats too are only suitable if the oil phase or fat phase of the drink according to the invention has a lower density than the aqueous phase.

As well as the actual oils or fats, the oils or fats can furthermore comprise in particular: carotenoids, fat-soluble vitamins such as vitamin A, D, E, K or derivatives thereof and phospholipids.

In one particular embodiment of the present invention, the oil phase or fat phase comprises the triglyceride of the conjugated linoleic acid, which is present as a 1:1 mixture of the two isomers c9,t11 and t10,c12. This triglyceride is commercially available from Cognis GmbH, Monheim, Germany.

In one embodiment of the invention, those hydrocolloids are used which do not increase, or do not significantly increase, the viscosity of the drink according to the invention. An insignificant increase is present if the viscosity of the drink at 20° C. and a hydrocolloid content of 1% by weight in the drink is increased not by more than 30%, preferably not by more than 20%, in particular not by more than 10%, compared with the drink without hydrocolloid.

In one particular embodiment, the drink according to the invention comprises, based on 100 parts by weight of aqueous phase, 0.01 to 10 parts by weight of oil phase or fat phase, in particular 0.025-5 parts by weight of oil phase or fat phase and 0.001 to 5 parts by weight of hydrocolloid, in particular 0.05 to 1 part by weight of hydrocolloid.

The present invention has numerous advantages. The drink has a neutral taste and it does not have an oily, greasy mouth feel. To prevent or retard creaming, for fat powders or emulsions, no further emulsifiers or weighting agents are required if the hydrocolloids according to the invention are used. To stabilize the drink, no additional technological measures, such as e.g. homogenization, are required.

In the present specification, all % data hereinbelow are % by weight, unless defined otherwise.

In one embodiment, the fat powder according to the invention has a fat content of 20-80%. In one embodiment, the fat powder according to the invention has a hydrocolloid content of 5-40%. In one embodiment, the fat powder according to the invention has a content of carrier substances of 15-75%. In one embodiment, the fat powder according to the invention has a water content of at most 8%.

The fat powders according to the invention can be produced by spray-drying or by other drying methods or by mixing.

In one embodiment, the emulsion according to the invention for producing the drink according to the invention has a fat content of 20-60%. In one embodiment, the emulsion according to the invention for producing the drink according to the invention has a hydrocolloid content of 2-10%. In one embodiment, the emulsion according to the invention for producing the drink according to the invention has an emulsifier content of 0.5-5%. In one embodiment, the emulsion according to the invention for producing the drink according to the invention has a water content of 38-78%.

According to the invention, suitable carrier substances are in particular: milk protein, soya protein, gum arabic, modified starch, e.g. succinate starch (E 1450). Carrier substances can serve to emulsify the fat in the water phase before the spray-drying and later in the powder state to envelope the fat.

According to the invention, emulsifiers can also be used. According to the invention, suitable emulsifiers are: monoglycerides of fatty acids and esters thereof, lecithins, sugar esters, polysorbates, polyglycerol esters. The specified carrier substances can also sometimes have an emulsifying effect, meaning that sometimes the addition of emulsifiers can be dispensed with.

Emulsion drinks can be produced from the following ingredients: drink base, a fat powder according to the invention or an emulsion according to the invention, water, other additives.

According to the invention, drink base is understood as meaning a semi-finished product which generally comprises apart from water, sugar and acid all ingredients which are necessary for producing a standardized drink, such as e.g. fruit juice or fruit juice concentrate, sweetening component (e.g. sugar or sweetener), aromas, coloring fruit extracts or plant extracts, antioxidants, vitamins etc.

According to the invention, of suitability as other additives are: antioxidants, dyes, fruit extracts, plant extracts, aroma substances.

### EXAMPLES

In the present specification, all % data are percentage by weight, unless defined otherwise.

The trade marks used below refer to the products defined below and are available via the stated sources of supply.
Tonalin® TG 80 is triglyceride which comprises ca. 80% (GC area percent) conjugated linoleic acid (based on the total amount of fatty acid esters). The conjugated linoleic acid consists to ca. 99% by weight of the isomers c9,t11 and t10,c12, which are present in the mass ratio of ca. 1:1; source of supply: Cognis GmbH, Monheim, Germany
Tonalin® 35 WDP is a water-dispersible powder which consists of Tonalin® TG 80 (50% by weight) on gum arabic as carrier; source of supply: Cognis GmbH, Monheim, Germany
Tonalin® AH 265 comprises 60% Tonalin® TG 80 and 39.95% gum arabic and 0.05% ascorbyl palmitate; source of supply: Cognis GmbH, Monheim, Germany
Kelcogel® PS is a mixture of sucrose, gellan (E 418) and pectin; source of supply: CP Kelco Germany GmbH, Groβenbrode, Germany
Kelcogel® F is a gellan; source of supply: CP Kelco Germany GmbH, Groβenbrode, Germany
The gum arabic used was the commercial product Quick-Gum Type 8074; available from ALFRED L. WOLFF GmbH, Hamburg, Germany
The pectin (E 440) used was the commercial product Genu Pectin VIS, available from CP Kelco Germany GmbH, Groβenbrode, Germany. This is a pectin standardized with sucrose; here, standardized means that the pectin is adjusted to a certain viscosity value with sucrose so that there is no change in the end product despite fluctuating raw material qualities (harvest-dependent)
Sisterna® SP 70 is a sugar ester (sucrose stearate and palmitate (monoester content 70%), Chemical Abstracts INDEX NAME: α-D-glucopyranoside, β-D-fructofuranosyl, hexadecanoate octadecanoate); source of supply: Sisterna B.V., 4704RG Roosendaal, The Netherlands
Soya lecithin was acquired from Cargill Deutschland GmbH, Krefeld, Germany. It carried the trade name Topcithin® NGM

### Example 1

Formulation of a Fat Powder with Hydrocolloids (Internal Reference: AH 213)

50% Tonalin® TG 80 (oil phase or fat phase)

24.2% Kelcogel® PS (hydrocolloid)

25.8% Gum arabic (carrier)

Preparation of a Fat Powder with Hydrocolloids Having the Formulation Above

The gum arabic and the Kelcogel® PS were stirred into water at approximately 20° C. 65 parts by weight of water were used based on 35 parts by weight of the formulation mentioned above. The resulting dispersion was heated to 50-55° C. Tonalin® TG 80 (at room temperature) was then dispersed into this first dispersion (water phase) with vigorous stirring. The dispersion obtained in this way was homogenized in two stages (with the pressure settings 120/30 bar in the homogenizer). The spray-drying was carried out with an atomizing disk at 24 000 revolutions per minute and at an incoming air temperature of 185° C.

### Example 2

Formulation of an Emulsion with Hydrocolloids

22% Tonalin® TG 80 (oil phase or fat phase)

8% Kelcogel® PS (hydrocolloid)

2% Sisterna® SP 70

1% soya lecithin

67% water

Citric acid to adjust the pH to 4.0

Preparation of an Emulsion with Hydrocolloids Having the Formulation Above

Tonalin® TG 80 and soya lecithin were heated to 50° C. and then mixed together. They formed the oil phase. The Sisterna® SP 70 and the Kelcogel® PS were dispersed in cold water. The oil phase cooled to 20° C. was then dispersed in the water phase. The dispersion was then adjusted to pH 4.0 with citric acid. This dispersion was then homogenized in circulation (5 cycles) in two stages (250/30 bar).

### Example 3

Formulation of an Emulsion Drink

0.94% fat powder with hydrocolloids according to example 1

6.5% drink base (orange-carrot-lemon from Rudolf Wild GmbH & Co. KG, Eppelheim/Heidelberg, Germany, Type 35000080660000)

92.56% water

Preparation of an Emulsion Drink with Hydrocolloids Having the Formulation Above

The three components were mixed, homogenized if necessary and pasteurized (at least 85° C. for 30 seconds). The emulsion drinks obtained in this way were then bottled.

### Example 4

Formulations of Emulsion Drinks Tested in Example 4:

SR 1049: 97.85% multivitamin juice, 2.15% Tonalin® 35 WDP

SR 1051: 97.55% multivitamin juice, 2.15% Tonalin® 35 WDP, 0.3% Kelcogel® PS

SR 1054: 97.35% multivitamin juice, 2.15% Tonalin® 35 WDP, 0.5% Genu Pectin VIS

SR 1170: 99.06% sports drink (isotonic refreshment drink),
0.94% fat powder (formulation example 1)

SR 1049 is a comparison formulation without hydrocolloid. Formulations SR 1051, SR 1054 and SR 1170 are in accordance with the invention.

Preparation of Emulsion Drinks with the Formulations with Hydrocolloids Having the Above Formulation SR 1049, SR 1051, SR 1054 and SR 1170

The dry substances were stirred into a multivitamin juice or a sports drink with stirring. This mixture was gently stirred continuously for 10 min. The mixture was then homogenized in one stage at 150 bar. Then, the mixture was heated to 85° C. for 30 s and then cooled to room temperature. The emulsion drink was poured into bottles and stored in the standing position and in the lying position. When it comes to creaming, this is evidently more rapid for the samples in the lying position.

Assessment of the Drinks According to Example 4

In the case of formulations SR 1051 and SR 1054 (both according to the invention), no creaming of the fat powder was evident even after storage for 5 weeks. Even in the case of formulation SR 1170, no creaming was evident after storage for 4 weeks. In the case of comparative example SR 1049, considerable creaming is visible after just 2 hours.

Sensory Assessment After Storage for 4 Days

| | Formulation | | |
|---|---|---|---|
| | SR 1049 | | |
| Taste | (comparison) | SR 1051 | SR 1054 |
| rancid | 0 | 0 | 0 |
| sticky | 0 | 0 | 0 |
| bitter | 0.17 | 0.17 | 0.17 |
| strange | 0.67 | 0.67 | 0.50 |

Assessment:
0=no taste, not evident
1=slight difference, slight taste
2=considerable difference, strong taste
3=very considerable difference, very strong taste

In sensory terms, no significance difference between the formulations was thus established.

### Example 5

Comparison of the Stability (No Creaming) and of the Viscosity of Emulsion Drinks with Different Hydrocolloids

The emulsion drinks described in the table below were prepared and tested. In all cases, what is called a sports drink was taken as a basis.

| | Experiment number | | | | | | | |
|---|---|---|---|---|---|---|---|---|
| | SR 1596 | BK 731 | SR 1569 | SR 1597 | SR 1571 | SR 1598 | SR 1566 | SR 1562 |
| Hydrocolloid | 0.25% | | 1.5% | | 1.8% | | 0.025% | 0.02% |
| | Kelcogel ® PS | | Genu Pectin VIS | | Genu Pectin VIS | | Kelcogel ® F | Kelcogel ® F |
| Ingredients | Gellan and pectin | | Pectin | | Pectin | | Gellan | Gellan |
| Tonalin ® | 1.35% Tonalin ® | | 1.95% Tonalin ® | | 1.95% Tonalin ® | | 1.95% Tonalin ® | 1.95% Tonalin ® |
| | AH 265 | | 35 WDP | | 35 WDP | | 35 WDP | 35 WDP |
| Düsseldorf | 3.2 mPas | 3 mPas | | 27 mPas | | 40 mPas | | |
| Bohlin C-VOR, | | | | | | | | |
| 1200 rpm | | | | | | | | |
| 23° C., PP40, | | | | | | | | |
| 0.3 mm gap | | | | | | | | |

| | | | | | |
|---|---|---|---|---|---|
| Appearance | stable | creams | stable | gels | creams |

A stable drink was only obtained with a mixture of gellan and pectin or with pectin on its own. In the case of gellan as the sole hydrocolloid, however, this had to be used in such large amounts to prevent creaming that an undesirably high viscosity of the drink was the result.

1-15. (canceled)

16. A drink which is an oil-in-water emulsion comprising an aqueous phase, an oil phase or fat phase which is dispersed in the aqueous phase, and at least one hydrocolloid, wherein the oil phase or fat phase has a lower density than the aqueous phase, and wherein the hydrocolloid is a mixture of gellan and pectin.

17. The drink of claim 16, wherein the drink comprises, based on 100 parts by weight of aqueous phase, 0.01 to 10 parts by weight of oil phase or fat phase and 0.001 to 5 parts by weight of hydrocolloid.

18. The drink of claim 17, wherein the viscosity of the drink at 23° C. is not higher than 50 mPas, as measured using a rotary viscometer of the Bohlin C-VOR type at 23° C. and the parameters 1200 rpm, PP40 (“plate plate 40 mm”) and 0.3 mm gap.

19. The drink of claim 16, wherein the hydrocolloid is a mixture of gellan and pectin in the mass ratio 1:10 to 10:1.

20. The drink of claim 16, wherein the oil phase or fat phase comprises the triglyceride of conjugated linoleic acid which is present as an approximate 1:1 mixture of the two isomers c9,t11 and t10,c12.

21. The drink of claim 16, wherein the oil phase or fat phase comprises omega-3-fatty acids in the form of their glycerol esters.

22. The drink of claim 16, wherein the oil phase or fat phase comprises phytosterols or fatty acid esters of phytosterols.

23. The drink of claim 16, wherein the drink further comprises a component selected from the group consisting of aroma substances, sweeteners, sugars, dyes, antioxidants, plant extracts, fruit extracts, and mixtures thereof.

24. The drink of claim 16, wherein the drink comprises less than 0.1% by weight of proteins, and preferably comprises no proteins.

25. The drink of claim 16, wherein the drink comprises less than 0.1% by weight of emulsifiers.

26. The drink of claim 16, wherein the drink does not comprise emulsifiers.

27. A fat powder for producing the drink of claim 16, wherein the fat powder comprises the oil phase or fat phase and the hydrocolloid.

28. An emulsion for producing the drink of claim 16, wherein the emulsion comprises the oil phase or fat phase, the hydrocolloid and a portion of the aqueous phase of the drink.

29. A method for producing the drink from the fat powder of claim 27, comprising dispersing the fat powder in the aqueous phase of the drink.

30. A method for producing the drink from the emulsion of claim 28, comprising bringing together the emulsion with the as yet lacking aqueous phase.
